(19) United States
(12) Patent Application Publication
(10) Pub. No.: US 2006/0077945 A1
(43) Pub. Date: Apr. 13, 2006

(54) System and method for validating networked devices

(75) Inventors: Amarender Reddy KethiReddy, Corona, CA (US); Weihsiung William Chow, Cerritos, CA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/961,273

(22) Filed: Oct. 8, 2004

(51) Int. Cl. H04J 3/16

(52) U.S. Cl. 370/346; 370/449

(57) ABSTRACT

A system and method are provided for validating network-connected devices. The method comprises: discovering network-connected devices; providing a list of validation queries associated with validation criteria; after discovery, sending validation queries from the list, in a predetermined order, to each discovered device; ceasing to send validation queries to a discovered device, once a validation query has been successfully acknowledged; generating a validation table cross-referencing validation criteria to discovered devices; and confirming validation criteria associated with the discovered devices in response to using the validation table. More specifically, generating the validation table includes cross-referencing failed validation queries with each discovered device. Then, confirming validation criteria associated with the discovered devices in response to using the validation table includes ceasing to send failed validation queries.

### BACKGROUND OF THE INVENTION

1. Field of the Invention

This invention generally relates to digital document processing and, more particularly, to an improved system and method for validating the characteristics of a network-connected device.

2. Description of the Related Art

Network scanning applications, such as Sharp's SharpDesk, typically broadcast specific messages over the network from a network client, such as a personal computer, in order to find standalone scanners, or devices such as multifunctional peripherals (MFPs). These MFP devices may include scanners, copiers, printer-enabled copiers, fax, and email capabilities. Generally, the technique of broadcasting a signal over a network to identify networked devices is referred to in the art as “discovery.”

Scanners, such as those found on MFPs, have various configurations and capabilities. These qualities, of course, change as more modern MFPs replace or accompany older models. Thus, a discovery tool might identify a large number of MFPs on a network, but over time, only a subset of the available MFPs possess characteristics that are of interest to a network scanning application. In order to eliminate MFP's whose scanners do not meet certain requirements, the network scanning application sends an additional message to the MFPs, after discovery, requesting more information about the MFP's scanner. Based on the response to the requested information, a decision is rendered concerning the compatibility of the MFP's scanner and the network scanning application. This screening process is typically referred to as “validation”.

The MFP detection and validation processes occur continuously, in order to automatically determine if any new or upgraded devices are added to the network. The process determines if these new/upgraded devices are compatible with the needs of the network client. The client requirements can be added as an element to the network scanning software. In some situations, it is critical that the same MFP is still online, so validation of that MFP is repeated. For example, to determine if a particular MFP has been disconnected, broken, or has been assigned a new address. Since validation is performed very frequently, the efficiency of the validation process is critical to the overall performance of the network scanning system. Typically, a list of validators is embedded in the network scanning application. The application runs through the list of validators for each MFP, until the validator matching the MFP is found.

Different models of the MFPs have different “criteria” that are considered for validation purposes. Thus, network scanning applications typically have multiple validators to validate the various MFP models. In the simplest case, each MFP has a different validator. However, a common validator may be shared by a subset of MFPs. For example, all the MFPs made by a particular manufacturer may share a common validator. Validators are applied in a specific predetermined order for each of the MFPs discovered in the network. Based on the result of the specific validation, an MFP is either “accepted” or “rejected”.

For example, the network client requires an MFP with a duplex (2-sided) scanning capacity. In a simple case, each MFP in the system may have a different validator. Since one particular MFP is associated with the last validator on the list, the entire list of validators must be checked, before that MFP can finally be validated. Thus, the validation process is not particularly efficient. The validation state of MFPs can be saved as a fixed value to increase efficient. However, as mentioned above, the state or validity of an MFP is subject to change.

The validation redundancy inherent in conventional validation approaches has several shortcomings that load network traffic each time a validation process is executed by the client's network scanning application. The conventional validation approaches are also time consuming from the perspective of the network client user.

It would be advantageous if the validator of a network-connected device could be checked more efficiently.

### SUMMARY OF THE INVENTION

This application describes a method for increasing the efficiency of an MFP validation process by learning from previous validation cycles. In one aspect of the invention, a “learning” or validation table is created that encompasses prior histories of the validation process. The validation table is subsequently used during the validation process to eliminate the validation redundancies associated with conventional method and, therefore, reduces network traffic and time required for validation.

Accordingly, a method is provided for validating network-connected devices. The method comprises: discovering network-connected devices; providing a list of validation queries associated with validation criteria; after discovery, sending validation queries from the list, in a predetermined order, to each discovered device; ceasing to send validation queries to a discovered device, once a validation query has been successfully acknowledged; generating a validation table cross-referencing validation criteria to discovered devices; and confirming validation criteria associated with the discovered devices in response to using the validation table.

More specifically, generating the validation table includes cross-referencing failed validation queries with each discovered device. Then, confirming validation criteria associated with the discovered devices in response to using the validation table includes ceasing to send failed validation queries. Further, the failed validation queries are cross-referenced to device information, such as make or model number. Then, the correct validator can be assigned to any new device entering the network, once its device information has been determined.

Additional details of the above-described method and a system for validating network-connected devices are provided below.

### BRIEF DESCRIPTION OF THE DRAWINGS

FIG. 1 is a schematic block diagram of a system for validating network-connected devices.

FIG. 2 is a diagram illustrating the relationship between validators and device information.

FIG. 3 is a diagram illustrating an exemplary validation table.

FIG. 4 is a diagram illustrating an exemplary discovery table.

FIG. 5 is a diagram illustrating another exemplary validation table.

FIG. 6 is a flowchart illustrating the initial validation process of the present invention validation process.

FIG. 7 is a flowchart illustrating a method for validating network-connected devices in a signal-bearing medium tangibly embodying a program of machine-readable instructions executed by a digital device.

### DETAILED DESCRIPTION

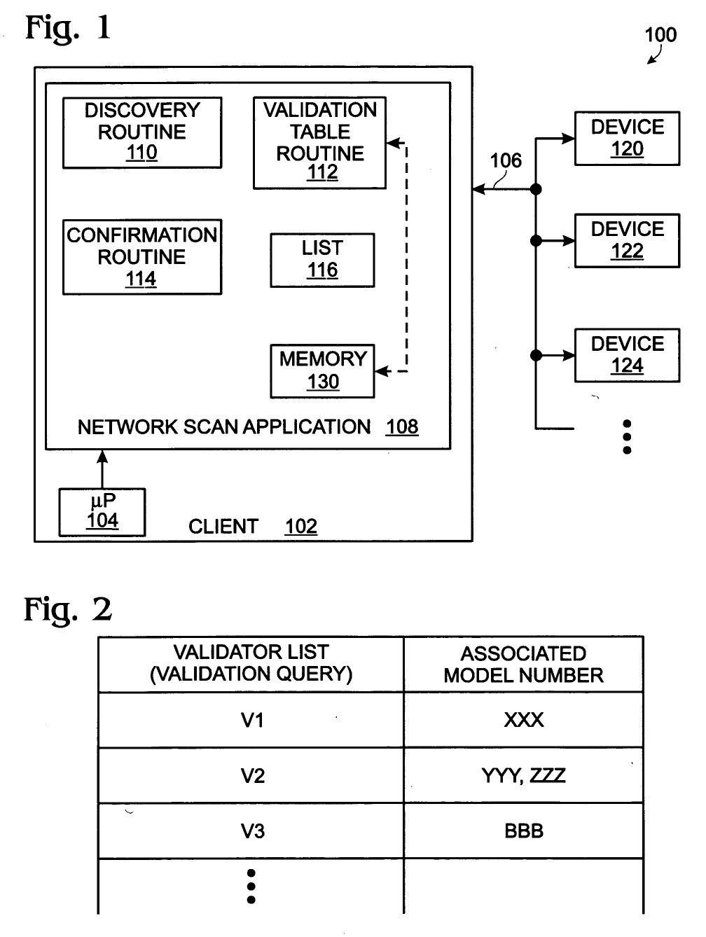

FIG. 1 is a schematic block diagram of a system for validating network-connected devices. The system 100 comprises a client digital computing device 102, or network client that includes a microprocessor (uP) 104 and a network port on line 106. Line 106 represents a network that may be an intranet, local area network, or Internet to name a few examples. A network scanning application 108 is embedded in the client 102. The network scanning application 108 includes a list of microprocessor-readable instructions. A discovery routine 110 is used to discover devices connected to the client 102. A validation table routine 112 cross-references validation criteria to discovered devices. A confirmation routine 114 uses the validation table to confirm validation criteria associated with the discovered devices.

The network scanning application 108 also includes a list 116 of validation queries (validators) associated with validation criteria. In some aspects of the system, the list 116 can be updated by looking in a window registry. In this manner, new validators can be added as new devices are introduced to market. The confirmation routine 114 sends validation queries from the list 116 to each discovered device after discovery. Shown are connected devices 120, 122, and 124. In one aspect the devices 120, 122, and 124 are MFPs. The confirmation routine 114 ceases to send validation queries to a discovered device, once a validation query has been successfully acknowledged. More specifically, the validation table routine 112 cross-references failed validation queries with each discovered device 120, 122, and 124. Note, the invention is not limited to use with any particular number of networked devices.

The confirmation routine 114 sends validation queries from the list to a particular device in a predetermined order. Typically, a device is selected. Then, each validator from the list is checked against the selected device, until a validator succeeds. For example, if device 120 is being validated, the confirmation routine checks the validators in the order dictated by the list; V1, followed by V2, followed by V3, and so on. After every device has been checked against the first validator, the next validator is selected and the process repeated.

Some examples of validation queries that may be sent request information such as device manufacturer, device model, and device capabilities, such as scanning, printing, and printing capabilities to name a few examples. For example, the network client may require an MFP that has an 11 by 17 inch paper tray.

FIG. 2 is a diagram illustrating the relationship between validators and device information. In one aspect, the confirmation routine generates an initial validation query that collects network-connected device information after discovery, and cross-references device information to successfully acknowledged validation queries. For example, the device information may be model number.

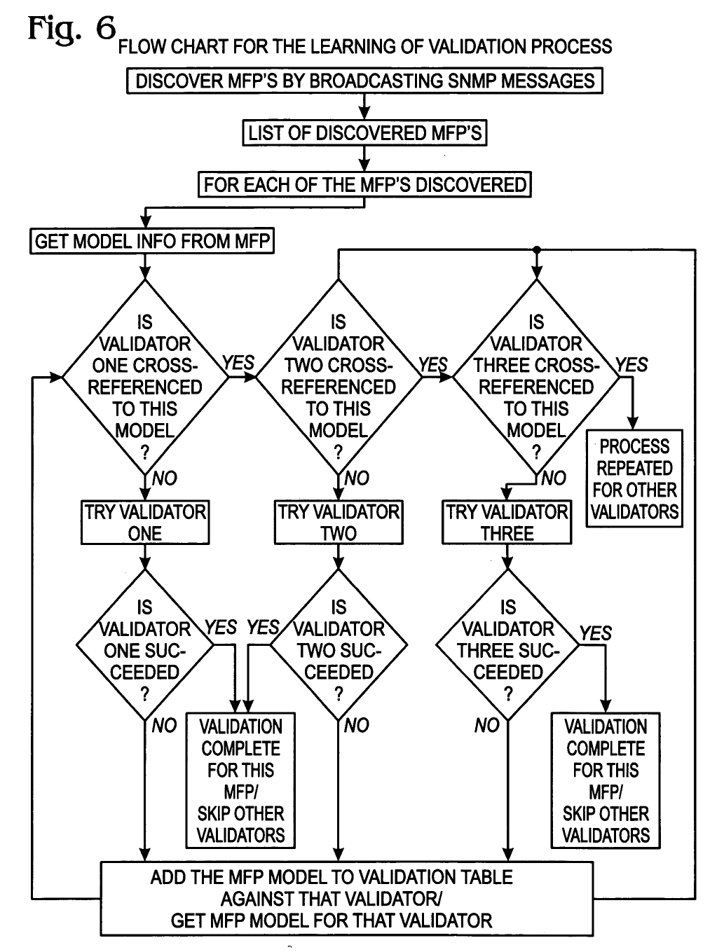

Alternately, the device information can be cross-referenced to failed validation queries. Then, the confirmation routine automatically cross-references failed validation queries with devices sharing the same device information. Thus, the initial validation query need only be performed a single time for a particular device, even if the network adds more devices with the same model number, see the explanation of FIG. 6 below.

As shown in FIG. 2, each validator can be associated with device information, such as model number. The initial validation query may be sent in a simple network management protocol (SNMP) message. However, the system is not limited to any particular format.

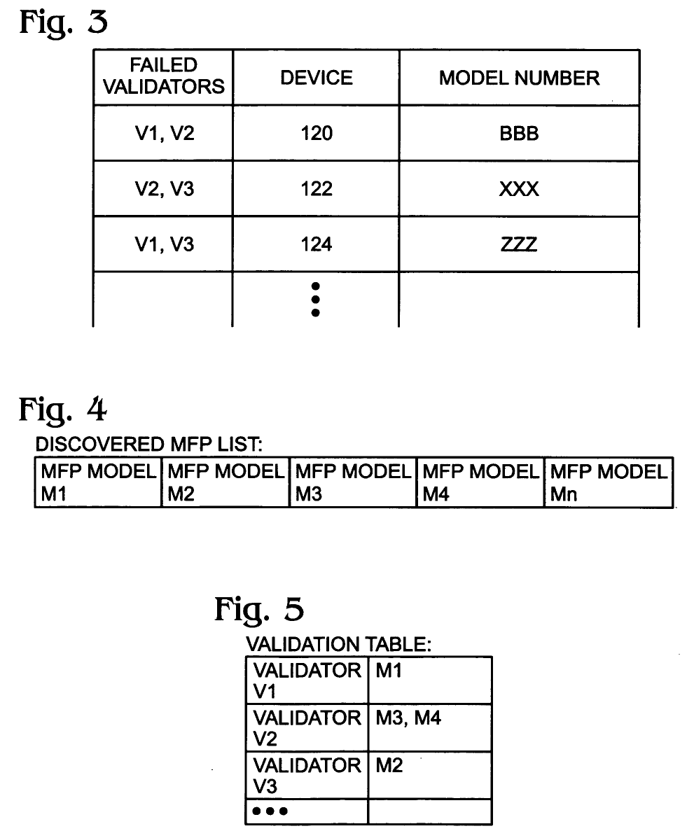

FIG. 3 is a diagram illustrating an exemplary validation table. The confirmation routine confirms validation criteria associated with a device in response to using the validation table by ceasing to send failed validation queries. Shown in the table is a column that registers whether a validation query has failed with respect to a particular device. More particularly, the table also shows the failed validation queries cross-referenced to device information, in this case model number. Since the model numbers are also cross-referenced to devices, the validator that is used to query a device can be selected after determining the device model number. The end result is that, for each device, all the validation queries, but one, will be marked as failed. Thus, the confirmation routine uses the validation table to send a single validation query to each discovered device. Since validators V1 and V2 are marked as failed with respect to device 120, model number “BBB”, only validator V3 will be used. Thus, the system still sends a validator to each device in the network as often as required by the network client. However, the efficiency of the process is increased as only a single validator is sent to each device, after the initial validation process.

In another aspect, the confirmation routine eliminates a first discovered device from the confirmation procedure if the validation table shows only failed validation queries for the first device. In this manner, the system ceases to validate devices that are not considered desirable with respect to the client's requirements. In a different aspect, the confirmation routine may repeat the initial validation routine for the first device, prior to eliminating the device, to determine if the device has been reconfigured with a different validator.

### Functional Description

Network scanning applications detect devices such as MFPs connected to the network. The discovery list of devices is usually large and diverse. Network scanning applications, such as Sharp's SharpDesk, use multiple validators to filter-out the “undesired” MFPs from the discovered list, based upon the characteristics of the MFP. Such characteristics may include the MFP's model, make, and capability. The validators are applied in a specific predetermined order to each of the discovered MFPs. The purpose of the validators is to acquire more information about MFPs on the network, so that MFPs that do not have certain characteristics can be eliminated from consideration.

Whereas validation processes are proven effective in screening unwanted MFPs, these processes increase network traffic and are time consuming. The problems conventionally associated with validation processes are exacerbated in network environments where MFPs are updated, or new ones added, as the validation process occurs on a continuous basis.

Initially, all the available validators are attempted in a predetermined order. Once the order is defined, the validation process tries each validator sequentially, as specified by the predetermined order, until one of the validators successfully validates an MFP.

This system improves the efficiency of the validation process by learning from the previous validation results and building a “learning table”, referred to herein as a validation table. Prior to executing a validation process, the validation table is accessed. The table has entries for unsuccessful validators, defined by characteristics such as model number, against each MFP. Therefore, when a particular MFP is to be validated, that failed validators can be skipped, thereby reducing the network traffic and time.

If a validator fails to validate an MFP in the initial validation process, the validator (i.e., model information of the MFP) is stored in the validation table. In this example it can be generalized that a particular validator that will not work with certain models of MFPs. If additional MFPs with that same model number (validator) are added to the network, it is not necessary to perform an initial validation procedure on the added MFPs, as their failed validators associated with this model MFP are already know. Thus, the initial validation procedure can skipped, improving network efficiency.

Using the network scanning application, the discovery process returns the list of devices that respond to SNMP broadcast messages. To each of the discovered devices, multiple validators are applied in the predetermined order to filter out the undesirable MFPs from the discovered list. During the validation process, the results of the validation are stored in a persistent way, as a file or in system registry.

The steps of the validation method are outlined below:

1) A network client detects responding devices using a network discovery process.

2) The model information of the responding devices is queried through SNMP message. In this example, the model numbers are referenced against validators. The devices with no model information are not valid MFPs, and need to be validated.

3) The network scanning application has finite number of validators and order of the validators is predetermined for efficiency.

4) For each of the MFPs discovered, each of the validators is applied in sequence. If a validator fails to validate a MFP, then the model/make of that MFP is stored in a persistent way for later retrieval. This validator will be skipped if the same model of MFP is encountered in subsequent validation.

5) If all the validators fail to validate a MFP, then that MFP is recognized as “decoy”. If a MFP of the same model is encountered again, all validators can be skipped.

6) Each time a new model of the MFP is validated, the validation is updated. This learning process continues automatically.

FIG. 4 is a diagram illustrating an exemplary discovery table.

FIG. 5 is a diagram illustrating another exemplary validation table. The validation table can be interpreted as follows:

1. Skip validating with validator V1 for all models of MFP M1.

2. Skip validating with validator V2 for all models of MFP M3 and M4.

3. Skip validating with validator V3 for all models of MFP M2.

FIG. 6 is a flowchart illustrating the initial validation process of the present invention validation process. After discovery, the model number of each MFP is determined. If the model number of a particular device is already known, then the initial validation procedure is unnecessary, as the model number has already been cross-referenced to a particular validator. If the model number is not in the validation table, then the MFP is checked against the list of validators. Once a validator is assigned to the new model number, it becomes unnecessary to perform the initial validation procedure for any like-model MFPs that are added to the network.

The validation table records the failure experience of validators with some MFP's model numbers. The purpose of the validation table is to learn, so as to avoid the same validation failure repeatedly. This permits some unnecessary validation queries to be skipped with respect to each particular model of MFP (since they will not succeed anyway), improving the network performance.

The following table is built from earlier validation experiences. It cross references each validator to the MFP models that do not respond to that particular validator.

| Validator | Failed MFP Model |
|---|---|
| V1 | |
| V2 | xxx, yyy, zzz, uuu |
| V3 | xxx, yyy, uuu |
| V4 | uuu |
| V5 | |

If MFP model number uuu is being validated, validator V1 is initially attempted. If V1 is successful, then the validation process is finished. If V1 is unsuccessful, validators V2, V3, and V4 can be skipped, as they are known to fail for the uuu model number. So, validator V5 is attempted. Note, after learning that V1 fails with respect to model number uuu, that information can be added to the validation table. The next time that a uuu model number is validated, the V1 validator can be skipped.

Alternately, the validation table may cross-reference validators to device information or device capabilities, as follows:

| Validator | Criteria |
|---|---|
| V1 | C1.1, C1.2 |
| V2 | C2.1, C2.2, C2.3 |
| V3 | C3.1, C3.2 |

In this implementation, the validation table is static and fixed at design time. Basically, the validator knows what it should look for in the MFP responses. There is no particular need for this table to be built in run time. Generally, the validation table is constructed in run time based on validation experience. It's almost impossible to predict the response of all future models of MFPs with a particular validator at design time.

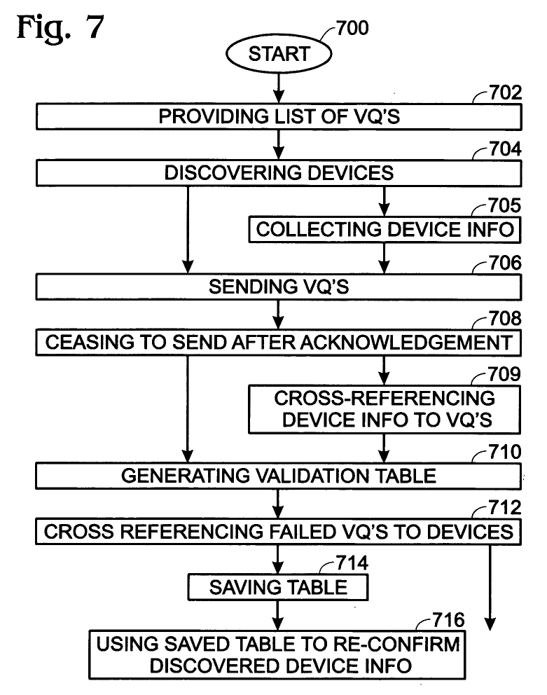

FIG. 7 is a flowchart illustrating a method for validating network-connected devices in a signal-bearing medium tangibly embodying a program of machine-readable instructions executed by a digital device. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 700.

Step 702 provides a list of validation queries (VQs) associated with validation criteria. For example, the validation query may concern an MFP's ability to perform duplex scanning. As noted above, the list is updateable, Step 704 discovers network-connected devices, such as MFPs. In some aspects, Step 705 collects device information, after discovery, in an initial validation query. For example, a device's model number may be collected. In one aspect, the initial validation queries can be sent in a simple network management protocol (SNMP) message.

Step 706 sends validation queries from the list to each discovered device after discovery. Typically, the validation queries are sent from the list to a particular device in a predetermined order. Step 708 ceases to send validation queries to a discovered device, once a validation query has been successfully acknowledged. In one aspect, Step 709 cross-references device information to failed validation queries. Step 710 generates a validation table cross-referencing validation criteria to discovered devices. More specifically, Step 710 cross-references failed validation queries with each discovered device. In one aspect, Step 710 automatically cross-references failed validation queries with devices sharing the same device information. Thus, a particular model number may become associated with a particular validator (validation query).

Step 712 confirms validation criteria associated with the discovered devices in response to using the validation table. More specifically, Step 712 confirms validation criteria associated with the discovered devices by ceasing to send failed validation queries. Alternately stated, Step 712 confirms validation criteria by sending a single validation query to each discovered device.

In another aspect, Step 714 saves the validation table. In Step 716, following a subsequent discovery of network-connected devices, uses the saved validation table discovered device information, such as model number. That is, the device information is not recollected after the subsequent discovery.

In a different aspect, confirming validation criteria associated with the discovered devices in response to using the validation table (Step 712) includes eliminating a first discovered device from the confirmation procedure if the table shows only failed validation queries for the first device. In another aspect, sending validation queries from the list, after discovery, to each discovered device (Step 706) includes sending queries such as device manufacturer, device model, or device capabilities.

A system and method for validating network-connected devices has been presented. Although examples have been given using the invention in the context of network-connected MFP's, it should be understood that the invention is not limited to any particular kind of device function. Other variations and embodiments of the invention may be recognized by those skilled in the art.

We claim:

1. In a signal-bearing medium tangibly embodying a program of machine-readable instructions executed by a digital device, a method for validating network-connected devices, the method comprising:
discovering network-connected devices;
generating a validation table cross-referencing validation criteria to discovered devices; and
confirming validation criteria associated with the discovered devices in response to using the validation table.

2. The method of claim 1 further comprising:
providing a list of validation queries associated with validation criteria;
after discovery, sending validation queries from the list to each discovered device;
ceasing to send validation queries to a discovered device, once a validation query has been successfully acknowledged; and
wherein generating the validation table includes cross-referencing failed validation queries with each discovered device.

3. The method of claim 2 wherein sending validation queries from the list to each discovered device after discovery includes sending validation queries from the list to a particular device in a predetermined order.

4. The method of claim 2 wherein confirming validation criteria associated with the discovered devices in response to using the validation table includes ceasing to send failed validation queries.

5. The method of claim 4 wherein confirming validation criteria associated with the discovered devices in response to using the validation table includes sending a single validation query to each discovered device.

6. The method of claim 4 wherein confirming validation criteria associated with the discovered devices in response to using the validation table includes eliminating a first discovered device from the confirmation procedure if the table shows only failed validation queries for the first device.

7. The method of claim 2 wherein sending validation queries from the list, after discovery, to each discovered device includes sending queries selected from the group including device manufacturer, device model, and device capabilities.

8. The method of claim 1 wherein discovering network-connected devices includes a client device discovering network-connected multifunctional peripherals (MFPs).

9. The method of claim 2 further comprising:
after discovery, collecting device information in an initial validation query;
cross-referencing device information to failed validation queries; and
wherein cross-referencing failed validation queries with each discovered device includes automatically cross-referencing failed validation queries with devices sharing the same device information.

10. The method of claim 9 further comprising;
saving the validation table;
following a subsequent discovery of network-connected devices, using the saved validation table discovered device information.

11. The method of claim 9 wherein collecting device information in the initial validation query includes sending initial validation queries in a simple network management protocol (SNMP) message.

12. A system for validating network-connected devices, the system comprising:
a client digital computing device including a microprocessor and a network port;
a network scanning application, embedded in the client, including a list of microprocessor-readable instructions including:
a discovery routine to discover devices connected to the client;
a validation table routine cross-referencing validation criteria to discovered devices; and
a confirmation routine that uses the validation table to confirm validation criteria associated with the discovered devices.

13. The system of claim 12 wherein the network scanning application further includes:
a list of validation queries associated with validation criteria;
wherein the confirmation routine sends validation queries from the list to each discovered device, and ceases to send validation queries to a discovered device, once a validation query has been successfully acknowledged; and
wherein validation table routine cross-references failed validation queries with each discovered device.

14. The system of claim 13 wherein the confirmation routine sends validation queries from the list to a particular device in a predetermined order.

15. The system of claim 13 wherein the confirmation routine confirms validation criteria associated with a device in response to using the validation table by ceasing to send failed validation queries.

16. The system of claim 15 wherein the confirmation routine uses the validation table to send a single validation query to each discovered device.

17. The system of claim 15 wherein the confirmation routine eliminates a first discovered device from the confirmation procedure if the validation table shows only failed validation queries for the first device.

18. The system of claim 13 wherein the confirmation routine sends validation queries selected from the group including device manufacturer, device model, and device capabilities.

19. The system of claim 12 wherein the discovery routine discovers network-connected multifunctional peripherals (MFPs).

20. The system of claim 13 wherein the confirmation routine sends an initial validation query and collects network-connected device information after discovery, cross-references device information to failed validation queries, and automatically cross-referencing failed validation queries with devices sharing the same device information.

21. The system of claim 20 wherein the confirmation routine sends the initial validation queries in a simple network management protocol (SNMP) message.

22. The system of claim 20 wherein the network scanning application saves the validation table;
wherein the network scanning application initiates a subsequent instantiation of the discovery routine; and
wherein the confirmation routine uses the saved validation table discovered device information.
